(19) United States
(12) Patent Application Publication
(10) Pub. No.: US 2026/0152369 A1
(43) Pub. Date: Jun. 4, 2026

(54) WORK MACHINE

(71) Applicant: SUMITOMO HEAVY INDUSTRIES, LTD., Tokyo (JP)

(72) Inventors: Yasuhiro YAMAMOTO, Kanagawa (JP); Keita NAKAMORI, Kanagawa (JP)

(21) Appl. No.: 19/405,922

(22) Filed: Dec. 2, 2025

(30) Foreign Application Priority Data
Dec. 4, 2024 (JP) 2024-211620

(51) Int. Cl. B66C 13/06; B66C 13/46

(52) U.S. Cl. CPC B66C 13/063; B66C 13/46

(57) ABSTRACT

A work machine includes a rope having a lower end portion configured to suspend a load, and a suspension fulcrum portion configured to suspend the rope and be movable. The suspension fulcrum portion is provided with a suspension fulcrum positioning device configured to acquire position information of the suspension fulcrum portion. The work machine is configured to move the suspension fulcrum portion based on the position information of the suspension fulcrum portion acquired by the suspension fulcrum positioning device and a set target position.

### CROSS-REFERENCE TO RELATED APPLICATIONS

This application claims priority to Japanese Patent Application No. 2024-211620, filed Dec. 4, 2024, the entire content of which is incorporated herein by reference.

### BACKGROUND

### 1. Technical Field

The present disclosure relates to a work machine.

### 2. Description of Related Art

Related art discloses an operation assistance system of a work machine (crane) for assisting an operator with an operation of setting down a suspended load (suspended object) held at the lower end of a wire rope at a target position (target-setting down surface). In this work machine, an operation assistance is provided by assisting the operator with recognizing the target position for setting down the suspended load by superimposing the target position on displayed image information obtained by a camera.

However, in the case where the target position is located in the blind spot of the camera, it is difficult to make the operator recognize the target position by indicating the target position in the image information. In other words, the image information obtained by the camera alone may not be sufficient to assist the operator with an operation of moving the suspended load to a freely selected target position.

### SUMMARY

According to one aspect of the present disclosure, a work machine includes a rope having a lower end portion configured to suspend a load, and a suspension fulcrum portion configured to suspend the rope and be movable. The suspension fulcrum portion is provided with a suspension fulcrum positioning device configured to acquire position information of the suspension fulcrum portion. The work machine is configured to move the suspension fulcrum portion based on the position information of the suspension fulcrum portion acquired by the suspension fulcrum positioning device and a set target position.

### BRIEF DESCRIPTION OF THE DRAWINGS

FIG. 1 is a side view illustrating an example of a crane according to an embodiment;

FIG. 2 is a block diagram schematically illustrating an example of a configuration of the crane according to the embodiment;

FIG. 3 is a perspective view illustrating a target position to which the crane and a suspension fulcrum portion are moved;

FIG. 4A is a side view illustrating an installation example of a suspension fulcrum positioning device;

FIG. 4B is a front view illustrating an installation example of the suspension fulcrum positioning device;

FIG. 5 is a front view illustrating an installation example of a lower-end wire positioning device;

FIG. 6 is a flowchart illustrating an example of a processing procedure for registering a target position in a simple operation mode in a controller according to the embodiment;

FIG. 7 is a diagram illustrating an example of a screen in a simple operation mode displayed by a display controller;

FIG. 8 is a flowchart illustrating a processing procedure for controlling movement of a boom by a controller in a simple operation mode;

FIG. 9A is a plan view schematically illustrating an example of an operation of moving the suspension fulcrum portion to a target position;

FIG. 9B is a plan view schematically illustrating an example of an operation of recognizing sway of a boom hook; and

FIG. 10 is a schematic diagram illustrating a configuration example of a remote control system for a crane according to a modified example.

### DETAILED DESCRIPTION

The present disclosure provides a work machine that can move the lower end of a rope to a target position with accuracy.

Hereinafter, an embodiment of the present disclosure will be described with reference to the drawings. In each of the drawings, the same components are denoted by the same reference numerals, and redundant descriptions may be omitted. It should be noted that the embodiments described below are not intended to limit the invention but are exemplary, and all features and combinations thereof described in the embodiments are not necessarily essential to the invention.

### Overall Configuration of Crane 100

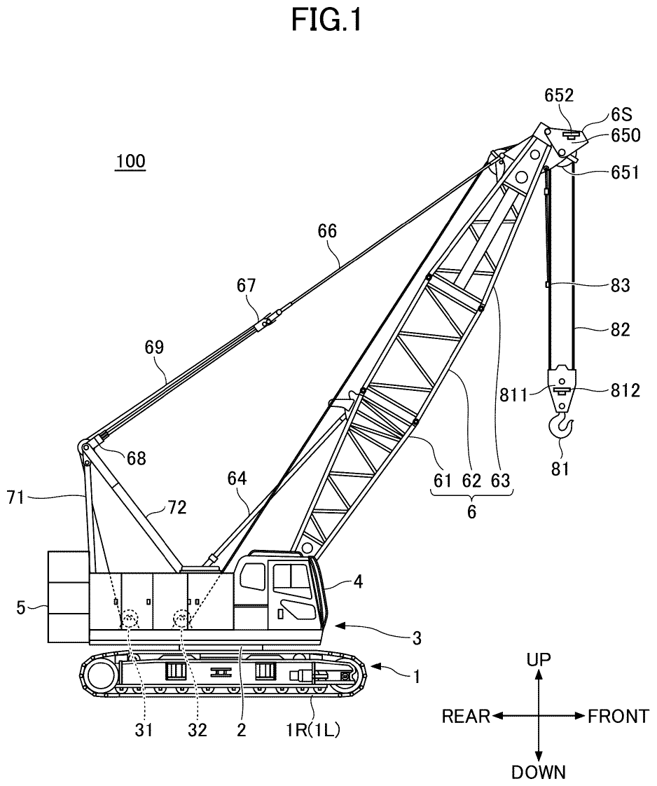

As an example of a work machine according to an embodiment of the present disclosure, a mobile crane 100 illustrated in FIG. 1 will be described. FIG. 1 is a side view illustrating an example of the crane 100 according to the embodiment. Hereinafter, the longitudinal (front-rear), lateral (left-right), and vertical (up-down) directions of the crane 100 are described based on the corresponding directions as seen from the perspective of the occupant (hereinafter also referred to as the operator) of the crane 100.

The crane 100 according to the embodiment is a so-called mobile crawler crane. The crane 100 includes a self-propelled crawler-type lower traveling body 1, an upper slewing body 3 slewably mounted on the lower traveling body 1, and an attachment AT mounted on the front side of the upper slewing body 3 in a raisable and lowerable manner.

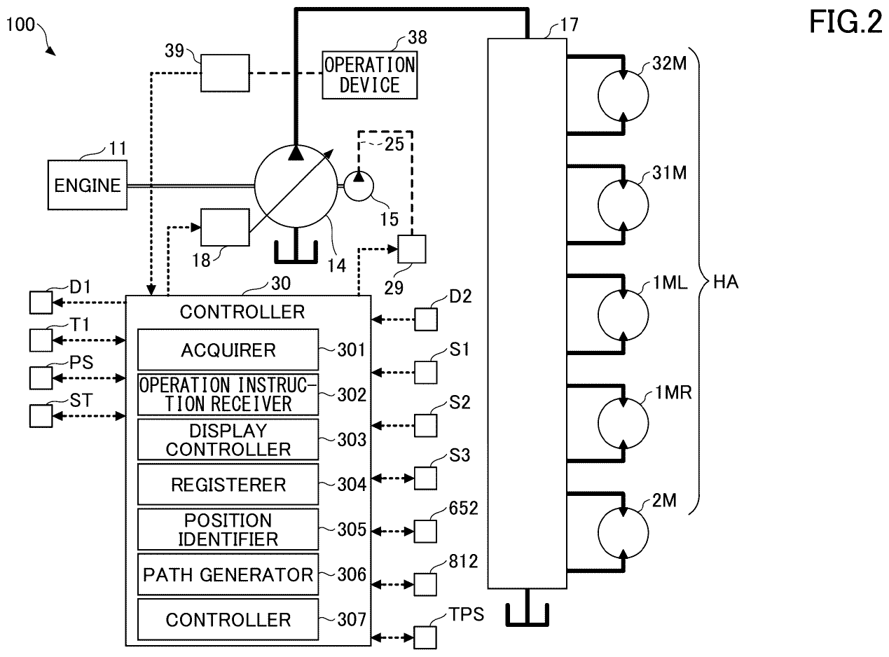

The lower traveling body 1 includes, for example, a pair of left and right crawlers 1L and 1R. Each crawler of the lower traveling body 1 is hydraulically driven by a left traveling hydraulic motor 1ML and a right traveling hydraulic motor 1MR (see FIG. 2), so that the crane 100 travels.

The upper slewing body 3 slews with respect to the lower traveling body 1 by hydraulically driving a slewing mechanism 2 by a slewing hydraulic motor 2M (see FIG. 2).

The upper slewing body 3 is provided with a cab 4 in which an operator sits and operates the crane 100 at an adjacent position on the right side of the attachment AT. The upper slewing body 3 is provided with a counterweight 5 on the rear side which balances the weight of the attachment AT and a load.

The attachment AT conveys a load hung on the attachment AT. The attachment AT is composed of a boom 6 including a lower boom 61 connected to a boom mounting part of the upper slewing body 3 in a raisable and lowerable manner, an intermediate boom 62 connected to the distal end of the lower boom 61, and an upper boom 63 connected to the distal end of the intermediate boom 62. The boom 6 has sufficient rigidity, being formed by assembling a plurality of frames.

The length of the attachment AT can be changed by increasing or decreasing a plurality of interconnectable intermediate booms 62 of the boom 6. The attachment AT is provided, at the rear side of the distal end of the lower boom 61, with a backstop 64 for regulating the turn of the boom 6 to the rear side.

The crane 100 further includes a pendant rope 66, an upper spreader 67, a lower spreader 68, a boom luffing wire rope 69, a gantry 71, and a gantry raising/lowering cylinder 72.

One end of the pendant rope 66 is connected to the rear side of the distal end of the upper boom 63. The other end of the pendant rope 66 is connected to the upper spreader 67. The upper spreader 67 connects the pendant rope 66 and the boom luffing wire rope 69. The boom luffing wire rope 69 is wrapped around a boom luffing winch 31 provided on the upper slewing body 3, and is wound up or wound out in accordance with the driving of the boom luffing winch 31.

The lower spreader 68 is mounted on the distal end of the gantry 71, which is pivotably provided relative to the upper slewing body 3. The gantry raising/lowering cylinder 72 is provided on the upper slewing body 3 to raise or lower the gantry 71.

For example, in the crane 100, the boom luffing winch 31 winds up the boom luffing wire rope 69, while the gantry raising/lowering cylinder 72 raises the gantry 71. Then the upper spreader 67 pulls the pendant rope 66 and the boom 6 is thereby luffed up and moved backward. Similarly, the boom luffing winch 31 winds out the boom luffing wire rope 69, and the boom 6 is thereby luffed down and moved forward.

The crane 100 is provided with a boom hook 81, a wire rope 82 (rope), and a hook over-winding prevention device 83 to hang a load. The boom hook 81 is suspended from the wire rope 82 via a hook bracket 811. In other words, the boom hook 81 constitutes a lower end portion of the wire rope 82. The hook bracket 811 has a pulley (not illustrated) inside for hanging the wire rope 82.

One end of the wire rope 82 is fixed to a fixing part provided at the distal end of the boom 6. The wire rope 82 extends downward to the hook bracket 811 of the boom hook 81, and extends upward by turning back from the hook bracket 811. The wire rope 82 also extends to the rear side of the boom 6 by being hung over a point sheave 651 (supporting part) provided at the distal end of the boom 6, and is wound by a front winch 32 provided on the upper slewing body 3 from the rear side of the distal end of the boom 6. Furthermore, the hook over-winding prevention device 83 is provided on the wire rope 82, and defines the lifting limit of the boom hook 81.

In the crane 100, the front winch 32 winds up the wire rope 82 to lift the boom hook 81, and a suspended load is thereby lifted. Similarly, the front winch 32 winds out the wire rope 82 to lower the boom hook 8 and a suspended load is thereby lowered.

Next, the configuration of a drive system and a control system of the crane 100 will be described with reference to FIG. 2. FIG. 2 is a block diagram schematically illustrating an example of the configuration of the crane 100 according to the embodiment.

### Hydraulic Drive System

The hydraulic drive system of the crane 100 according to the embodiment is provided with hydraulic actuators HA for hydraulically driving the lower traveling body 1 (left and right crawlers), the upper slewing body 3, the attachment AT, and the like. The hydraulic actuators HA include the traveling hydraulic motors 1ML and 1MR, the slewing hydraulic motor 2M, a boom luffing hydraulic motor 31M, a front winch hydraulic motor 32M, and the like.

The slewing hydraulic motor 2M is an actuator for slewing the upper slewing body 3 with respect to the lower traveling body 1. The boom luffing hydraulic motor 31M is an actuator for operating the boom luffing winch 31. The front winch hydraulic motor 32M is an actuator for operating the front winch 32.

The hydraulic drive system of the crane 100 includes an engine 11, a main pump 14, a pilot pump 15, a control valve unit 17, and a regulator 18.

The engine 11 is a prime mover and a main power source in the hydraulic drive system. The engine 11 is, for example, a diesel engine using light oil as fuel. The engine 11 is mounted, for example, at the rear of the upper slewing body 3. The engine 11 rotates at a predetermined target rotational speed under the control of a controller 30, which is described later, and drives the main pump 14 and the pilot pump 15. However, the main power source of the crane 100 is not limited to the engine 11, and an electric motor may be adopted. In other words, the crane 100 may be an electric crane. The electric crane may be a battery type in which power is supplied to the electric motor by an on-board battery, or a wired type in which power is supplied to the electric motor from an external power source via a wire.

The main pump 14 supplies hydraulic oil to the control valve unit 17 through a high-pressure hydraulic line. The main pump 14 is mounted, for example, at the rear of the upper slewing body 3 in the same manner as the engine 11. The main pump 14 is, for example, a variable displacement hydraulic pump, and the tilt angle of the swashplate is adjusted by the regulator 18 under the control of the controller 30, whereby the stroke length of the piston is adjusted and the discharge flow rate (discharge pressure) of the hydraulic oil is controlled.

The control valve unit 17 is a hydraulic control device for controlling the hydraulic actuators HA in accordance with content of an operation or remote operation of the operation device 38 by the operator, or in accordance with an operation command regarding the automatic operation function that is from the controller 30. The control valve unit 17 is mounted, for example, at the center of the upper slewing body 3. The control valve unit 17 is connected to the main pump 14 via a high-pressure hydraulic line, and selectively supplies hydraulic oil supplied from the main pump 14 to the respective hydraulic actuators in accordance with an operation of the operator or an operation command that is output from the controller 30. Specifically, the control valve unit 17 includes a plurality of control valves (for example, a directional switching valve) for controlling a flow rate and a flow direction of hydraulic oil supplied from the main pump 14 to the respective hydraulic actuators HA.

### Operation System

The operation system of the crane 100 includes the pilot pump 15, the controller 30, a proportional valve 29, an operation device 38, and an operation sensor 39.

The pilot pump 15 supplies pilot pressures to various hydraulic devices via a pilot line 25. The pilot pump 15 is mounted, for example, at the rear of the upper slewing body 3 in the same manner as the engine 11. The pilot pump 15 is, for example, a fixed displacement hydraulic pump. The pilot pump 15 may be omitted. In which case, relatively high-pressure hydraulic oil discharged from the main pump 14 is reduced by a predetermined pressure reducing valve, and relatively low-pressure hydraulic oil is supplied to the various hydraulic devices as the pilot pressure.

The operation device 38 is provided near the operator's seat of the cab 4 and is used by the operator to perform various operations of the crane 100. The operation device 38 includes a pedal device and a lever device for operating the respective hydraulic actuators HA.

For example, the operation device 38 is configured as an electric type. The operation sensor 39 detects a direction and an amount of an operator's operation of the operation device 38, and outputs an operation signal corresponding to each operated actuator to the controller 30.

Then, the controller 30 outputs a control command corresponding to content of the operation signal, that is, a control signal corresponding to content of the operation of the operation device 38 to the proportional valve 29. Thus, a pilot pressure corresponding to content of the operation of the operation device 38 is input from the proportional valve 29 to the control valve unit 17, and the control valve unit 17 can drive each hydraulic actuator HA according to content of the operation of the operation device 38. A control valve (direction switching valve) for driving each hydraulic actuator incorporated in the control valve unit 17 may be of an electromagnetic solenoid type. In which case, an operation signal that is output from the operation device 38 may be directly input to the control valve unit 17 (electromagnetic solenoid type control valve).

The proportional valve 29 is provided for each hydraulic actuator HA, which is an operation target of the operation device 38. The proportional valve 29 is arranged in a conduit connecting the pilot pump 15 and the pilot port of the control valve in the control valve unit 17, and is configured to change the flow path area of the conduit. The proportional valve 29 operates in response to a control command that is output from the controller 30. Therefore, the controller 30 can supply hydraulic oil discharged from the pilot pump 15 to the control valve of each hydraulic actuator HA provided in the control valve unit 17 via the proportional valve 29 independently of the operator's operation of the operation device 38.

<User Interface System>

The user interface system of the crane 100 includes an operation device 38, an operation sensor 39, a display device D1, and an input device D2.

The display device D1 outputs various information to the operator of the crane 100 inside the cab 4. The display device D1 is provided at a place easily visible from the operator seated in the cab 4, and is a device for outputting various information in a visual manner, such as a liquid crystal display or an organic EL (electroluminescence) display.

The input device D2 is provided in a range close to the operator seated in the cab 4, and receives various inputs from the operator. An input signal received by the input device D2 is input to the controller 30. For example, the input device D2 may include a touch panel mounted on the display device, a touch pad provided around the display device, a button switch, a lever, a toggle, a knob switch provided on the operation device 38 (lever device), and the like. For example, the input device D2 may be a voice input device for receiving a voice input from the operator. The voice input device includes, for example, a microphone. Alternatively, the input device D2 may be a gesture input device for receiving a gesture input from the operator. The gesture input device includes, for example, an imaging device (indoor camera) installed in the cab 4.

### Communication System

The communication system of the crane 100 includes a communication device T1 capable of communicating with an external device. The communication device T1 is connected to a communication line and communicates with a device provided separately from the crane 100. An example of the apparatus provided separately from the crane 100 is a portable communication terminal held by a worker present at the work site. The communication device T1 may include a mobile communication module conforming to a standard such as 4G (4 th Generation) or 5G (5 th Generation). The communication device T1 may include, for example, a satellite communication module, a Wi-Fi (registered trademark) communication module, a Bluetooth (registered trademark) communication module, and the like.

### Control System

The control system of the crane 100 includes, for example, a slewing sensor S1, a boom luffing sensor S2, a length sensor S3, an upper slewing body positioning device PS, a storage device ST, and the controller 30.

The slewing sensor S1 outputs information about the slewing of the upper slewing body 3. The slewing sensor S1 detects a slew angular velocity of the upper slewing body 3 with respect to the lower traveling body 1, for example. The slewing sensor S1 also detects a slew angle. The slewing sensor S1 may be, for example, a gyro sensor, a resolver, a rotary encoder, or an IMU (inertial measurement unit). A detection signal corresponding to a slew angle or a slew angular velocity of the upper slewing body 3 by the slewing sensor S1 is input the controller 30.

The boom luffing sensor S2 outputs information about a raised or lowered status of the boom 6. The boom luffing sensor S2 detects, for example, a luffing angle (tilt angle) of the boom 6. The boom luffing sensor S2 may be, for example, a gyro sensor or an IMU. A detection signal corresponding to a luffing angle of the boom 6 by the boom luffing sensor S2 is input to the controller 30.

The length sensor S3 outputs information about a length of the wire rope 82 for hanging a load with the boom hook 81. The length sensor S3 detects, for example, the length of the wire rope 82 wound out from the front winch 32.

The upper slewing body positioning device PS measures the position of the upper slewing body 3. The upper slewing body positioning device PS is, for example, a GNSS (global navigation satellite system) positioning device, and detects the position and orientation of the upper slewing body 3. Detection signals corresponding to a position and an orientation of the upper slewing body 3 are input to the controller 30. The function of detecting the orientation of the upper slewing body 3 may be realized by an orientation sensor attached to the upper slewing body 3. The upper slewing body positioning device PS measures the current position of the crane 100 in a set reference coordinate system.

The reference coordinate system is, for example, a world geodetic system capable of specifying a position on the Earth. The world geodetic system is a three-dimensional orthogonal XYZ coordinate system having an origin at the center of gravity of the Earth, with an X-axis in the direction of the intersection of the Greenwich meridian and the equator, a Y-axis in the direction of longitude 90 degrees east, and a Z-axis in the direction of the North Pole.

The storage device ST is, for example, a readable and writable nonvolatile storage medium. For example, an SSD (solid state drive) or HDD (hard disk drive) may be adopted as the storage device ST.

The controller 30 controls the operation of each drive unit provided in the crane 100. The functions of the controller 30 may be realized by any hardware or any combination of hardware and software. For example, the controller 30 is configured mainly by a computer including a CPU (central processing unit), a memory device such as a RAM (random access memory), a nonvolatile auxiliary memory device such as a ROM (read only memory), an interface device for various inputs and outputs, and the like. The controller 30 realizes various functions by loading a program installed in the auxiliary memory device into the memory device and executing it on the CPU.

For example, the controller 30 controls the proportional valve 29 to control the operation of the hydraulic actuators HA of the crane 100, which is based on an operation of the operation device 38. The controller 30 may perform operation assistance for assisting the operator in conveying a suspended load to a target position on a ground plane (for example, a plane of two-dimensional coordinates of XY coordinates) of the crane 100. The assistance in operating the crane 100 may include a fully automatic operation in which the entire operation of the crane 100 is controlled, a semi-automatic operation in which a part of the operation of the crane 100 is controlled, and a guidance function for displaying an operation of the crane 100 on the display device D1 (or outputting from a speaker).

As an example, a semi-automatic operation is performed in which the controller 30 automatically controls the slewing movement and the luffing movement of the crane 100 while the operator of the crane 100 performs an operation of lifting and lowering a suspended load. In other words, the controller 30 controls only the slewing movement of the upper slewing body 3 and the luffing movement of the boom 6 to move the boom hook 81 to a target position at two-dimensional coordinates. In this semi-automatic operation, the controller 30 controls the slewing speed of the upper slewing body 3 and the luffing speed of the boom 6 in such a manner that sway of the suspended load is suppressed. When the fully automatic operation is performed, the controller 30 controls the operation of winding up and winding out the wire rope 82, in addition to the slewing control on the upper slewing body 3 and the luffing control on the boom 6.

In this semi-automatic operation, the controller 30 outputs an electric current to the proportional valve 29 to apply an appropriate pilot pressure to the control valve unit 17. Thus, the crane 100 can automatically control the slewing hydraulic motor 2M and the boom luffing hydraulic motor 31M. In order to perform such automatic control, the controller 30 internally constructs an acquirer 301, an operation instruction receiver 302, a display controller 303, a registerer 304, a position identifier 305, a path generator 306, and a controller 307 realized by the execution of a program by a CPU.

The acquirer 301 acquires detection results of various sensors provided on the crane 100. For example, the acquirer 301 acquires from the operation sensor 39 an operation signal indicating an operator's operation of the operation device 38. The acquirer 301 acquires a slew angular velocity and a slew angle of the upper slewing body 3 from the slewing sensor S1, a raised or lowered status of the boom 6 (for example, a luffing angle) from the boom luffing sensor S2, and information about a length of the wire rope 82 from the length sensor S3.

The acquirer 301 calculates the height of a suspended load from a length of the wire rope 82 and a luffing angle of the boom 6. The controller 30 may acquire imaging information showing a suspended load by an imaging device (not illustrated) of the crane 100 and calculate the height of the suspended load from the imaging information.

The operation instruction receiver 302 receives an operator's operation via the input device D2 or the operation device 38 or both of them. For example, the operation instruction receiver 302 receives pressing of a predetermined button of the operation device 38 in order to transition to a simple operation mode, which is a mode for performing semi-automatic operation. The “simple operation mode” is an operation mode for conveying a suspended load to a target position registered in advance when an input operation of the slewing operation lever of the operation device 38 is received.

The display controller 303 performs control for displaying information on the display device D1. For example, the display controller 303 displays a screen in the simple operation mode when an operation for transitioning to the simple operation mode is received.

In the simple operation mode, the registerer 304 registers a target position used for conveying a suspended load in the storage device ST. The target position is stored in the storage device ST, for example, when the controller 30 acquires position information transmitted from a target position detector TS that is set at the target position. A GNSS positioning device, for example, may be adopted as the target position detector TS. In which case, the target position detected by the target position detector TS is two-dimensional coordinates in the world geodetic system. The target position may be detected in three-dimensional coordinates including height information by performing altitude measurement by a pressure sensor. When storing the target position, the registerer 304 may convert the position information so as to place the target position in a crane coordinate system defined with respect to the upper slewing body 3 of the crane 100.

The position identifier 305 identifies both or either one of the current position of the distal end of the boom 6 and the current position of the boom hook 81. A point sheave 651 to which the wire rope 82 is suspended is provided at the distal end of the boom 6, and a sheave bracket 650 (bracket) rotatably supporting the point sheave 651 is provided (see FIG. 1). In other words, the distal end of the boom 6 corresponds to the suspension fulcrum portion 6S at which the wire rope 82 is suspended vertically downward by the point sheave 651 and moves integrally with the boom 6.

In order to position the current position of the suspension fulcrum portion 6S (the distal end of the boom 6), a suspension fulcrum positioning device 652 is provided at the distal end of the boom 6 in the crane 100 according to the embodiment. As the position of the suspension fulcrum portion 6S, the position identifier 305 can identify the position at which the wire rope 82 is suspended based on the position information of the suspension fulcrum positioning device 652 acquired via the acquirer 301.

The current position of the boom hook 81 is the position of the lower end portion of the wire rope 82 and basically overlaps the current position of the distal end of the boom 6 in plan view. However, the current position of the boom hook 81 may deviate from the current position of the suspension fulcrum portion 6S for various reasons, such as movement of the boom 6, vibrations and disturbances caused by wind, the sway of the boom hook 81, mechanical deflection of the crane 100, or the inclination of the entire crane 100. For accurate positioning, the crane 100 according to the embodiment is provided with a lower-end wire positioning device 812 at the hook bracket 811 of the boom hook 81. The position identifier 305 can identify the position of the boom hook 81 based on the position information of the lower-end wire positioning device 812 acquired via the acquirer 301. The configurations of the suspension fulcrum positioning device 652 and the lower-end wire positioning device 812 will be described later in detail.

The path generator 306 generates a target path for automatically conveying the boom hook 81 and a suspended load from the current position of the suspension fulcrum portion 6S to the target position in two-dimensional coordinates or three-dimensional coordinates indicating the ground plane (horizontal plane) of the crane 100. A well-known method can be used for generating a target path. For example, the path generator 306 generates a target path based on the difference in the slew angle between the current position of the distal end of the boom 6 and the target position, and the difference between the current luffing angle of the boom 6 and the luffing angle when the boom hook 81 reaches the target position.

The controller 307 controls slewing of the upper slewing body 3 and luffing of the boom 6 of the crane 100 based on the target path generated by the path generator 306. For example, the controller 307 moves the suspension fulcrum portion 6S from the current position to the target position along the target path in two-dimensional coordinates or three-dimensional coordinates based on the crane 100 through conjunction of the slewing control and the luffing control.

### Control of Suspension Fulcrum Portion 6S

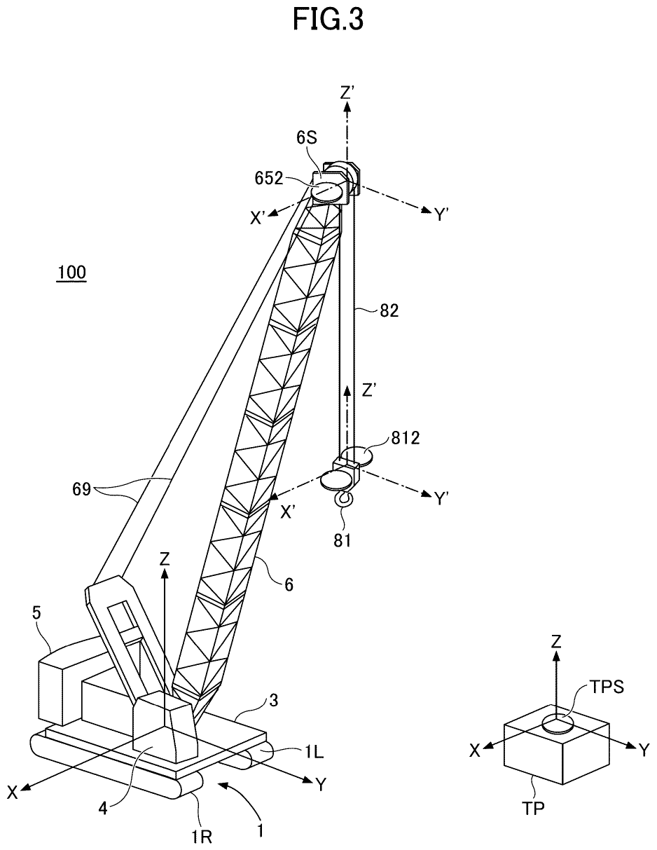

Hereinafter, the operation and control of the crane 100 to move the suspension fulcrum portion 6S, which is the distal end of the boom 6, to a target position TP will be described with reference to FIG. 3. FIG. 3 is a perspective view illustrating the crane 100 and the target position TP to which the suspension fulcrum portion 6S moves. FIG. 3 illustrates an example of moving the boom hook 81 to a suspended load, which is the target position TP, in order to perform the work of hanging the suspended load on the boom hook 81. For this reason, there is no suspended load on the boom hook 81. However, even in the case where the suspended load is conveyed being hung on the boom hook 81, the crane 100 may, as a matter of course, perform the automatic conveyance by setting the conveyance destination of the suspended load to the target position TP.

The boom hook 81 of the crane 100 is basically suspended vertically downward from the point sheave 651 provided at the suspension fulcrum portion 6S. Therefore, to move the boom hook 81 to the target position TP, it is sufficient to move the suspension fulcrum portion 6S so as to overlap the target position TP in plan view. Therefore, the controller 30 of the crane 100 according to the embodiment automatically generates a target path from the current position of the suspension fulcrum portion 6S to the target position TP in plan view, and moves the suspension fulcrum portion 6S along the target path.

To perform this control, it is important that the controller 30 accurately ascertains the position information of the target position TP and the position information of the suspension fulcrum portion 6S. For this reason, the crane 100 according to the embodiment is provided with the suspension fulcrum positioning device 652 for positioning the position of the suspension fulcrum portion 6S at the distal end of the boom 6, as described above. The crane 100 is further provided with the lower-end wire positioning device 812 for positioning the position of the lower end portion of the wire rope 82 on the hook bracket 811 of the boom hook 81, which is the lower end portion of the wire rope 82. For the suspension fulcrum positioning device 652 and the lower-end wire positioning device 812, a GNSS (global navigation satellite system) positioning device is adopted, and can carry out positioning in the world geodetic system.

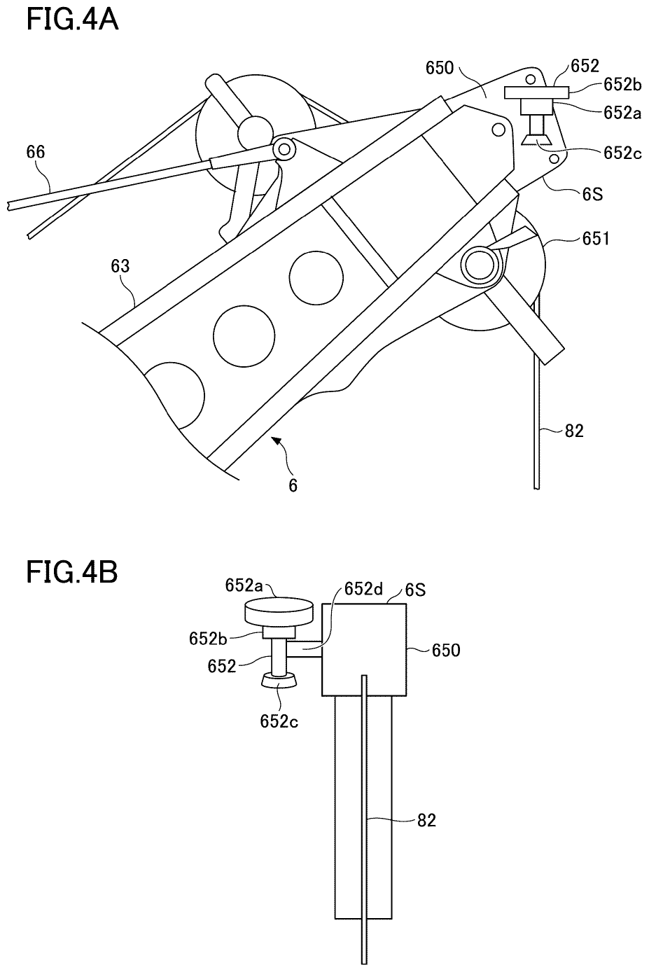

FIG. 4A is a side view illustrating an installation example of the suspension fulcrum positioning device 652. FIG. 4B is a front view illustrating an installation example of the suspension fulcrum positioning device 652. As illustrated in FIG. 4A, the suspension fulcrum positioning device 652 is fixed to the sheave bracket 650 at the distal end of the boom 6. The sheave bracket 650 is provided on both sides in the width direction of the point sheave 651 for suspending the wire rope 82, and rotatably holds the point sheave 651. In the sheave bracket 650, the suspension fulcrum positioning device 652 is installed on the vertical upward side of the wire rope 82 suspended from the point sheave 651.

As illustrated in FIG. 4B, the suspension fulcrum positioning device 652 is installed so as to project (separate) from one surface of the pair of sheave brackets 650. The suspension fulcrum positioning device 652, which is a GNSS positioning device, can receive signals from a plurality of satellites. In this case, the position information measured by the suspension fulcrum positioning device 652 would deviate from the actual position where the wire rope 82 is suspended. Therefore, the amount and direction of the projection from the wire rope 82 are taken into account for the position information measured by the suspension fulcrum positioning device 652, so that the suspension fulcrum positioning device 652 or the controller 30 can accurately ascertain information of the actual position of the wire rope 82.

The suspension fulcrum positioning device 652 fixed to the distal end of the boom 6 includes a positioning main body 652a and an antenna 652b for receiving signals from various satellites on the upper side of the positioning main body 652a. The suspension fulcrum positioning device 652 is provided with a weight 652c and a support bar 652d for supporting the suspension fulcrum positioning device 652 on the vertical lower side of the positioning main body 652a and the antenna 652b.

The positioning main body 652a calculates position information based on signals from various satellites received by the antenna 652b. The positioning main body 652a is connected to the controller 30 so as to be capable of information communication, and transmits the calculated position information to the controller 30.

The antenna 652b is formed in a disk shape. In order to enable highly accurate position detection, the size (diameter) of the antenna 652b is set to, for example, about 100 mm to 300 mm. Since the antenna 652b is open without any component installed above it, it is possible to stably receive signals from various satellites. Since the positioning main body 652a and the antenna 652b are arranged at positions protruding from the sheave bracket 650 by the support bar 652d, contact with the sheave bracket 650 is avoided.

The support bar 652d rotatably supports the positioning main body 652a and the antenna 652b about the axis of the support bar 652d. The weight 652c having a weight larger than that of the positioning main body 652a and the antenna 652b is adopted, and is made to be the support bar 652d, so that the weight 652c is constantly positioned on the lower side in the vertical direction. Thus, the positioning main body 652a and the antenna 652b are arranged so as to face upward constantly regardless of the luffing attitude of the boom 6, and position information can be acquired with high accuracy by using signals from various satellites.

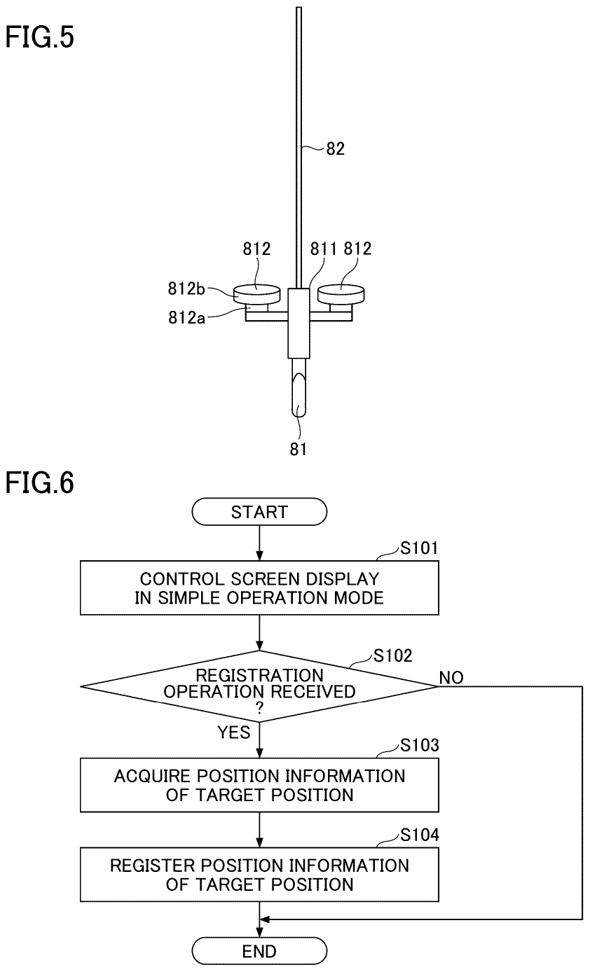

FIG. 5 is a front view illustrating an installation example of the lower-end wire positioning device 812. As illustrated in FIG. 5, the lower-end wire positioning device 812 is installed on the hook bracket 811 of the boom hook 81. In the crane 100 according to the embodiment, a pair of a first portion and a second portion of the lower-end wire positioning device 812 is installed on both sides in the width direction of the hook bracket 811 in order to attain stability of the attitude of the boom hook 81.

The first portion and the second portion of the lower-end wire positioning device 812 are respectively arranged at positions projecting symmetrically and at equal intervals from the hook bracket 811. This arrangement can suppress the change of the center of gravity of the boom hook 81 by the pair of the first portion and the second portion of the lower-end wire positioning device 812. Therefore, even when the first portion and the second portion of the lower-end wire positioning device 812 are installed, rotational or similar undesired movements of the boom hook 81 are reduced. Each of the first portion and the second portion of the lower-end wire positioning device 812 also includes a positioning main body 812a and an antenna 812b, similar to the positioning main body 652a and the antenna 652b of the suspension fulcrum positioning device 652.

The controller 30 (or one of the first portion or the second portion of the lower-end wire positioning device 812) simultaneously acquires position information of the pair of the first portion and the second portion of the lower-end wire positioning device 812, calculates an intermediate position between the pair of pieces of position information, and ascertains the intermediate position as the current position of the boom hook 81. Thus, the controller 30 can accurately ascertain the position information of the boom hook 81.

The target position positioning device TPS for determining the position information of the target position TP is further set at the target position TP as illustrated in FIG. 3, as described above. For example, when the boom hook 81 is moved relative to a suspended load at a target position, a worker in the vicinity of the suspended load carries the target position positioning device TPS and sets the target position positioning device TPS at the suspended load, thereby transmitting the position information of the target position TP to the controller 30. Alternatively, the crane 100 may move the suspension fulcrum portion 6S and the boom hook 81 just above the worker who carries the target position positioning device TPS as the target position TP.

When a suspended load is conveyed while being hung on the boom hook 81, the target position positioning device TPS is set in advance at a destination (for example, a platform on which the suspended load is to be placed) of the suspended load. Thus, the crane 100 can lower a suspended load to the target position TP by moving the suspension fulcrum portion 6S in accordance with the position information acquired by the target position positioning device TPS. Alternatively, the crane 100 may move the suspension fulcrum portion 6S and the suspended load directly above the worker by setting the worker who carries the target position positioning device TPS as the target position TP. When conveying the suspended load to the target position TP, the suspended load may be conveyed by setting a position slightly deviated from the position information of the target position positioning device TPS as the target position TP. Thus, contact between the conveyed suspended load and the target position positioning device TPS (or the worker) can be prevented.

The controller 30 can accurately move the suspension fulcrum portion 6S (the distal end of the boom 6) directly above the target position TP by acquiring and ascertaining the position information measured by the respective positioning devices as described above. At this time, the controller 30 can estimate the states of the suspension fulcrum portion 6S and the lower end portion of the wire rope 82 by repeating Kalman filter processing on the continuously acquired position information of the suspension fulcrum portion 6S and the position information of the lower end portion of the wire rope 82 (boom hook 81). For example, the controller 30 can smooth the position information which is continuous in time. This makes it possible to omit influences, such as movement of the boom 6, vibrations and disturbances caused by wind, the sway of the boom hook 81, mechanical deflection of the crane 100, or the inclination of the entire crane 100, and acquire the position information with high accuracy. The controller 30 can monitor in real time a state such that the target position TP is moved by an external force or the like by repeating the Kalman filter processing for the position information of the target position TP.

For example, in ascertaining the position information, the controller 30 generates three-dimensional coordinates with the slewing center of the crane 100 as a reference (zero point), and converts the position of the suspension fulcrum portion 6S and the target position TP into the three-dimensional coordinates. Thus, the controller 30 can satisfactorily recognize the relative positions of the suspension fulcrum portion 6S and the target position TP with respect to the upper slewing body 3.

It is preferable to convert the position of the lower end portion (boom hook 81) of the wire rope 82 into three-dimensional coordinates or two-dimensional coordinates with the suspension fulcrum portion 6S as a reference (zero point) (see arrows X′, Y′, and Z′ of the chain line in FIG. 3). Thus, the controller 30 can easily recognize the sway of the boom hook 81 with respect to the suspension fulcrum portion 6S (including load sway of the suspended load).

### Control of Semi-Automatic Operation

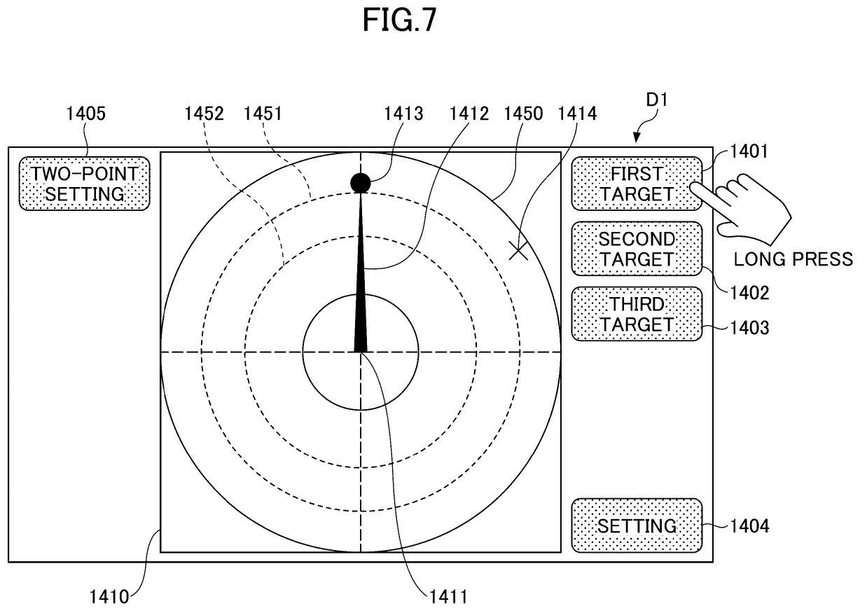

FIG. 6 is a flowchart illustrating an example of a processing procedure for registering the target position in the simple operation mode in the controller 30 according to the embodiment. When setting the target position TP for moving the suspension fulcrum portion 6S at the distal end of the boom 6, the controller 30 performs, for example, the flow illustrated in FIG. 6.

Specifically, the display controller 303 first performs control to display a screen in the simple operation mode on the display device D1 (step S101).

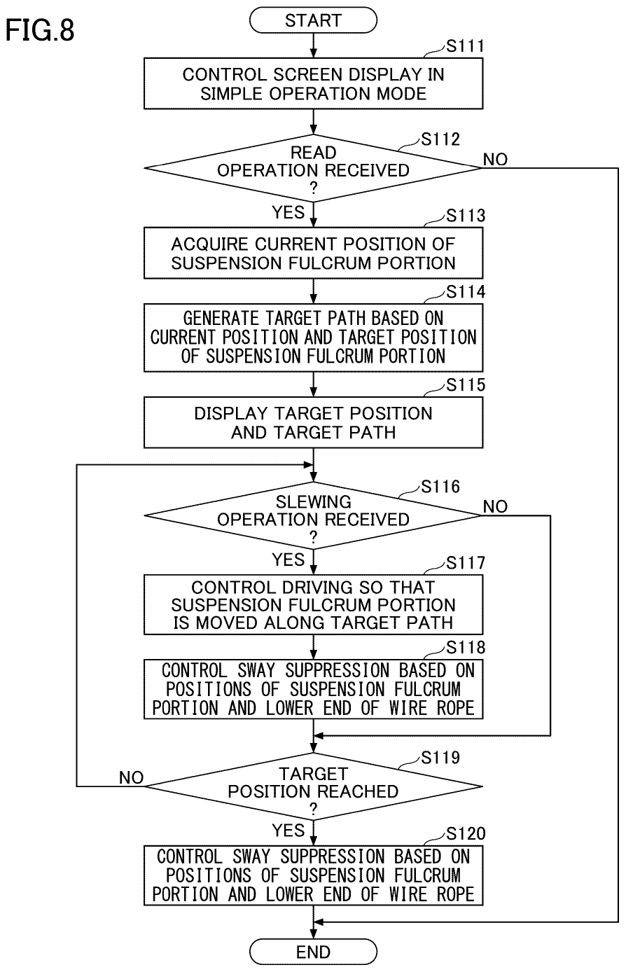

FIG. 7 is a diagram illustrating a screen in the simple operation mode displayed by the display controller 303. On the screen of in simple operation mode, a display area 1410, a first target button 1401, a second target button 1402, a third target button 1403, a setting button 1404, and a two-point setting button 1405 are displayed, for example.

The display area 1410 displays a coordinate system indicating a workable range of the crane 100 in two dimensions. The reference position 1411 indicates a slewing center of the crane 100.

The triangle 1412 and the circle icon 1413 in the display device D1 indicate a current state of the boom 6. Specifically, the triangle 1412 indicates a current direction of the boom 6 and a length according to the luffing state, and the circle icon 1413 indicates the suspension fulcrum of the distal end of the boom 6. The length of the triangle 1412 from the reference position 1411 to the circle icon 1413 becomes shorter as the boom 6 luffs up and becomes longer as the boom 6 luffs down.

The first circle 1450 indicates the longest distance that the distal end of the boom 6 can reach. The second circle 1451 and the third circle 1452 indicate each predetermined distance.

The first target button 1401, the second target button 1402, and the third target button 1403 are buttons for acquiring position information of the target position TP from the target position positioning device TPS and arranging the position information in a coordinate system (a two-dimensional coordinate system in FIG. 7) based on the crane 100. In other words, in the present embodiment, three target positions corresponding to the first target button 1401, the second target button 1402, and the third target button 1403 can be registered. In the display area 1410, the registered target position TP is indicated by an X icon 1414.

For example, when the operator long presses the first target button 1401, the acquirer 301 acquires position information of the target position TP from the target position positioning device TPS. The registerer 304 registers position information by converting the target position TP to two-dimensional coordinates or three-dimensional coordinates defined with respect to the crane 100, and displays an X icon 1414 in the display area 1410.

In assisting with an operation of the crane 100, the controller 30 presses any one of the first target button 1401, the second target button 1402, and the third target button 1403 to read the registered target position TP, and moves the suspension fulcrum portion 6S to the target position TP. However, the target position TP of the suspension fulcrum portion 6S need not be a final arrival point. For example, the suspension fulcrum portion 6S may be moved again to a second target position after being moved to the first target position.

The setting button 1404 is provided for performing various settings. The two-point setting button 1405 is used when the boom hook 81 of the crane 100 is moved between two positions.

Returning to FIG. 6, the operation instruction receiver 302 determines whether or not the registration operation by a long press of the first target button 1401, the second target button 1402, or the third target button 1403 has been received (step S102). If it is determined that the registration operation has not been received (No in step S102), the process ends without performing any particular processing.

If it is determined that the operation instruction receiver 302 has received the registration operation by a long press of the first target button 1401, the second target button 1402, or the third target button 1403 (Yes in step S102), the acquirer 301 acquires the position information of the target position TP which has been determined by the target position positioning device TPS as described above (step S103).

The registerer 304 stores the determined position information in the storage device ST in association with the long-pressed target button (the first target button 1401, the second target button 1402, or the third target button 1403) (step S104). At this time, the display controller 303 displays the acquired position information of the target position TP on the display device D1. For example, the display controller 303 displays the target position TP in the display area 1410, which is a coordinate system based on the crane 100, in relation to the position of the boom 6. The color of the target button in which the position information is registered may be different from the color of the target button in which the position information is not registered. Thus, the operator can recognize the target button on which the position information is registered when referring to the screen in the simple operation mode. The controller 30 can register the position information of the target position TP by performing the above control.

The method of registering a target position is not limited to the above, and various methods can be adopted. For example, prior to operation assistance, the operator may manually operate the upper slewing body 3 and the boom 6 so that the suspension fulcrum portion 6S overlaps the target position TP in the vertical direction, and presses the target button at this timing to register the current position of the suspension fulcrum portion 6S at the target position TP. In this way, in the registration of the target position TP, the target position TP when the crane 100 actually moves can be set with accuracy by using the position measured by the suspension fulcrum positioning device 652.

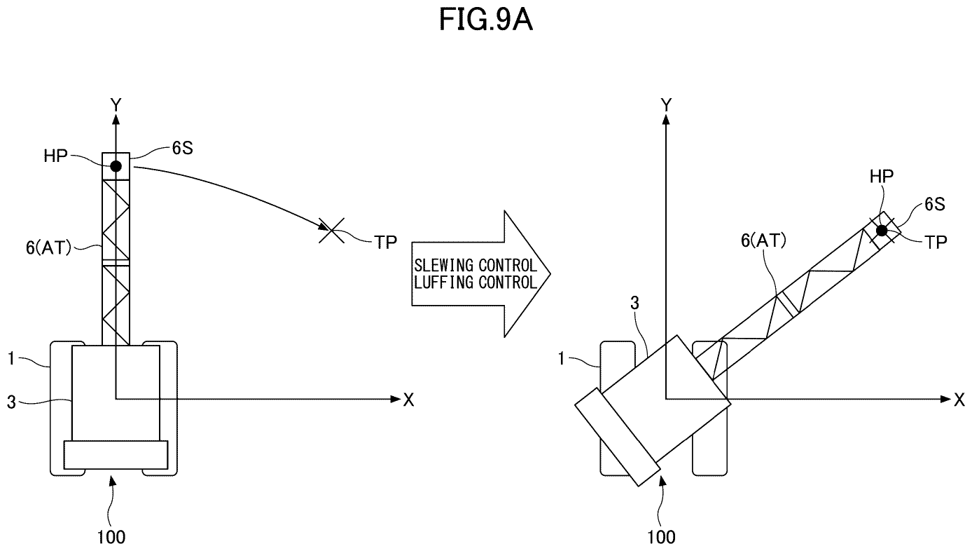

Next, the process of controlling the movement of the boom 6 in the simple operation mode will be described with reference to FIG. 8. FIG. 8 is a flowchart illustrating a process procedure in which the controller 30 controls the movement of the boom 6 in the simple operation mode.

The display controller 303 of the controller 30 performs control to display the screen of the simple operation mode on the display device D1 (step S111).

Next, the operation instruction receiver 302 determines whether or not the position information reading operation performed by pressing the target button has been received (step S112). If it is determined that the position information reading operation performed by pressing the target button has not been received (No in step S112), the process is ended.

If it is determined that the operation instruction receiver 302 has received the position information reading operation (Yes in step S112), the acquirer 301 acquires information on the current position of the suspension fulcrum portion 6S from the suspension fulcrum positioning device 652 provided at the distal end of the boom 6 (step S113). When acquiring the current position of the suspension fulcrum portion 6S, the display controller 303 may perform calibration processing to adjust the coordinate system of the crane 100 to the current position of the suspension fulcrum portion 6S.

Next, when the position information corresponding to the target button pressed by the operator is read from the storage device ST, the path generator 306 generates a target path of the suspension fulcrum portion 6S based on the current position of the suspension fulcrum portion 6S and the target position TP (step S114).

Then, the display controller 303 displays the current position, the target position TP, and the target path of the suspension fulcrum portion 6S on the display area 1410 (step S115). Thus, the operator can check the path when the suspension fulcrum portion 6S is moved by the semi-automatic operation by the controller 30. Therefore, the operator can visually confirm the surroundings of the crane 100 before starting the semi-automatic operation, and confirm whether or not the boom hook 81 or the like touches any obstacle when the suspension fulcrum portion 6S is moved along the target path.

Then, the operation instruction receiver 302 determines whether or not the slewing operation by the slewing operation lever included in the operation device 38 is received (step S116). When the operation instruction receiver 302 determines that the slewing operation by the slewing operation lever is received (Yes in step S116), the process proceeds to step S117.

The controller 307 controls the driving of either or both of the slewing hydraulic motor 2M and the boom luffing hydraulic motor 31M so that the suspension fulcrum portion 6S is moved along the target path (step S117). Based on the fact that the slewing operation is received, the controller 307 moves the suspension fulcrum portion 6S to the target position TP. At this time, it is preferable that the controller 307 simultaneously perform the slewing control for slewing the upper slewing body 3 at a constant slewing speed and the luffing control for luffing the boom 6 at a constant luffing speed so as to maintain the position of the suspended load in the height direction. Alternatively, the controller 307 may control the suspension fulcrum portion 6S in such a manner that the speed is changed at a predetermined maximum slewing speed or less and a predetermined maximum rolling speed or less in accordance with the inclination amount of the boom 6 or the like.

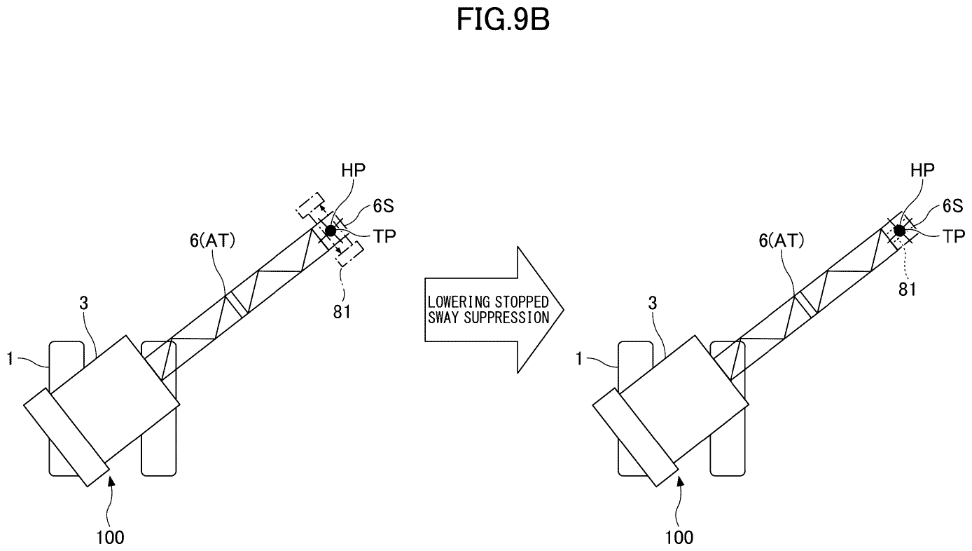

FIG. 9A is a plan view schematically illustrating an operation example of moving the suspension fulcrum portion 6S to the target position TP. FIG. 9B is a plan view schematically illustrating an operation example of recognizing sway of the boom hook 81. As illustrated in FIG. 9A, the crane 100 performs the slewing control of the upper slewing body 3 and the luffing control of the boom 6, thereby displacing the X-Y position of the suspension fulcrum portion 6S and controlling the suspension fulcrum portion 6S in such a manner that the position HP of the suspension fulcrum portion 6S overlaps the target position TP in the vertical direction.

When the boom 6 is moved, the controller 30 acquires the position information of the suspension fulcrum positioning device 652 and the position information of the lower-end wire positioning device 812, and performs the slewing control and the luffing control while ascertaining the position of the suspension fulcrum portion 6S and the position of the lower end of the wire rope 82 (step S118). In other words, the crane 100 can easily move the suspension fulcrum portion 6S along the target path by feeding back the position HP of the suspension fulcrum portion 6S and the position of the lower end of the wire rope 82 in real time.

Herein, the deviation between the position of the lower end of the wire rope 82 and the position of the suspension fulcrum portion 6S indicates sway of the boom hook 81 (or load sway when the boom hook 81 holds the suspended load) when the boom 6 is moved. The crane 100 recognizes sway of the lower end portion (boom hook 81, suspended load) of the wire rope 82 with respect to the suspension fulcrum portion 6S, and can perform control for suppressing sway of the lower end portion of the wire rope 82 (hereinafter also referred to as “sway suppression control”).

For example, the controller 30 monitors the relative position of the boom hook 81 with respect to the suspension fulcrum portion 6S, and when the position (sway) of the boom hook 81 reaches a threshold value or greater, performs the sway suppression control on the boom hook 81. As the sway suppression control on the boom hook 81, for example, the moving speed (slewing speed or luffing speed) of the boom 6 is reduced, or the moving path of the distal end of the boom 6 (suspension fulcrum portion 6S) is finely adjusted in the direction of sway. Alternatively, the moving speed of the boom 6 is controlled in such a manner that the lower end portion of the wire rope 82 follows the suspension fulcrum portion 6S, thereby reducing sway.

While the control for moving the suspension fulcrum portion 6S to the target position is being performed, the operator may monitor whether the boom hook 81 or the suspended load is in contact with an obstacle or not, and if it is likely that the boom hook 81 or the suspended load touches an obstacle, the operator may perform a hoisting operation or a lowering operation. The controller 307 hoists or lowers the boom hook 81 in accordance with the operator's operation to adjust the height of the boom hook 81 or the suspended load, thereby preventing the boom hook 81 or the suspended load from touching an obstacle or the like.

While the slewing control and the luffing control are being performed, the display controller 303 changes the display in the display area 1410 of the screen in the simple operation mode according to the slewing control and the luffing control being performed. For example, the display controller 303 may change the direction and length of the triangle 1412 and the circle icon 1413 according to the movement of the crane 100. The display controller 303 may change the length of the triangle 1412, the target position TP, and the target path according to the movement of the crane 100 without changing the direction of the triangle 1412.

Returning to FIG. 8, when it is determined that the slewing operation by the slewing operation lever is not received (No in step S116), the controller 307 does not control the driving of the slewing hydraulic motor 2M and the boom luffing hydraulic motor 31M. When the reception of the slewing operation is stopped before the suspension fulcrum portion 6S moves to the target position TP, the controller 307 stops the slewing control of the upper slewing body 3 and the luffing control of the boom 6. Thus, when the operator recognizes an obstacle or the like at the destination of the boom hook 81 and the suspended load by visual observation or the like, the semi-automatic operation can be stopped.

Then, the controller 307 determines whether or not the suspension fulcrum portion 6S has reached the target position TP of the target path (step S119). When it is determined that the suspension fulcrum portion 6S has not reached the target position TP (No in step S119), the process returns to step S116 and the same processing is performed.

If it is determined that the suspension fulcrum portion 6S has reached the target position TP of the target path (Yes in step S119), the controller 307 performs stop control of the slewing hydraulic motor 2M and the boom luffing hydraulic motor 31M.

At this time, the controller 30 may recognize sway of the lower end portion of the wire rope 82 based on the position information of the suspension fulcrum positioning device 652 and the position information of the lower-end wire positioning device 812, and perform sway suppression control (step S120). As illustrated in FIG. 9B, when the boom hook 81 is swaying, the position information of the lower end portion of the wire rope 82 shows a state in which the lower end portion is reciprocating with respect to the position HP of the suspension fulcrum portion 6S as the origin. The controller 30 can accurately recognize the sway of the lower end portion of the wire rope 82 (boom hook 81) based on the change in the position information.

For example, the position identifier 305 of the controller 30 calculates a difference between the position information of the suspension fulcrum portion 6S and the position information of the lower end portion of the wire rope 82 in two-dimensional coordinates (XY plane) or three-dimensional coordinates. This difference corresponds to the sway length of the lower end portion of the wire rope 82. Therefore, it can be recognized whether the sway of the lower end portion of the wire rope 82 is large by determining whether this difference is equal to or larger than a predetermined threshold value.

In the case where the lower end portion of the wire rope 82 sways greatly when the slewing hydraulic motor 2M and the boom luffing hydraulic motor 31M are stopped, the controller 30 may stop the lowering of the boom hook 81 and wait, or perform sway suppression control on the boom hook 81 as in the case of moving the boom 6. For example, the lowering of the swaying boom hook 81 and the suspended load can be stopped by forcibly stopping a winding-out operation at the front winch 32, and the contact between the swaying boom hook 81 or the suspended load and surrounding objects can be thereby prevented. The sway suppression control includes moving the boom 6 in the sway direction and performing an operation of winding up the wire rope 82. The sway of the boom hook 81 can be suppressed by making the wire rope 82 suspended from the point sheave 651 shorter by the winding-up operation. For example, to perform the winding-up operation, it is preferable that the controller 30 cause the display device D1 to display information regarding the position of the boom hook 81 and information regarding sway or the like and/or provide guidance for urging the operator to operate the winding-up operation, so that the operator performs the winding-up operation. The operation of winding up the wire rope 82 may be automatically controlled by the controller 30.

When the sway of the lower end portion of the wire rope 82 stops, the lower end portion (boom hook 81) of the wire rope 82 located on the lower side in the vertical direction of the suspension fulcrum portion 6S coincides with the target position TP. Thus, the operator of the crane 100 performs an operation of winding down the wire rope 82 located at the target position TP. The operator can easily hook the suspended load on the boom hook 81 lowered to the target position TP or remove the suspended load from the boom hook 81.

The controller 30 can determine whether or not the boom hook 81 is rotating based on position information acquired from each of the first portion and the second portion of the lower-end wire positioning device 812. For example, the controller 30 recognizes whether or not the boom hook 81 is rotating and the rotational speed of the boom hook 81 based on a time-series change in a direction indicating the other position from one position in position information of the pair of the first portion and the second portion of the lower-end wire positioning device 812. When the rotational speed of the boom hook 81 is not less than a predetermined rotational speed, the controller 30 controls the movement of the suspension fulcrum portion 6S. The control of the movement of the suspension fulcrum portion 6S is rotation suppression control, and may be the same as the above-described sway suppression control on the boom hook 81. The predetermined rotational speed is a speed determined according to embodiments.

When the suspension fulcrum portion 6S reaches the target position TP, the target position TP (target position positioning device TPS) may be moved in advance of lowering the boom hook 81 or the suspended load. Thus, contact between the boom hook 81 or the suspended load and the target position positioning device TPS or the operator can be prevented. In this case, during the process of recognizing the target position TP, the operation of lowering the boom hook 81 or the suspended load may be forcibly stopped.

Furthermore, in the crane 100, the position HP of the suspension fulcrum portion 6S and the position of the boom hook 81 may deviate even when the wire rope 82 does not sway, for various reasons, such as mechanical deflection of the boom 6, wind (external force), inclination of the crane 100 itself, or the like. For this reason, the controller 30 may control the movement of the boom 6 based on the position of the suspension fulcrum portion 6S (the distal end of the boom 6) until the suspension fulcrum portion 6S reaches the target position TP, and control based on the position of the lower end portion of the wire rope 82 when the suspension fulcrum portion 6S is in the vicinity of the target position TP. In this way, the position of the lower end portion of the wire rope 82 can be smoothly adjusted to the target position TP. If it is recognized that the lower end portion of the wire rope 82 sways greatly in the vicinity of the target position TP, it is preferable that the controller 30 choose to continue controlling based on the position of the suspension fulcrum portion 6S.

As described above, the crane 100 according to the embodiment can accurately detect the position of the suspension fulcrum portion 6S by the suspension fulcrum positioning device 652 installed at the suspension fulcrum portion 6S, and move the suspension fulcrum portion 6S directly above the target position TP. Thus, compared with the case where the suspension fulcrum portion 6S, the lower end portion of the wire rope 82, the target position, and the like are recognized by using an imaging device, LiDAR, or the like, the crane 100 can measure the position information regularly and accurately, and can satisfactorily execute the automatic control.

The position of the suspension fulcrum portion 6S of the crane 100 can also be calculated based on the information of the length of the boom 6 and the detection result of another sensor (slewing sensor S1, boom luffing sensor S2) of the crane 100. However, when an error occurs in the sensor readings in the case of the long boom 6, the error of the position of the suspension fulcrum portion 6S located at the distal end may be 10 cm or more. On the other hand, the error of the positioning of the suspension fulcrum positioning device 652, which is a GNSS positioning device, can be suppressed to about several centimeters. Therefore, the suspension fulcrum positioning device 652 can greatly improve the detection accuracy of the position of the suspension fulcrum portion 6S compared with other positioning methods.

It should be noted that the work machine (crane 100) according to the present disclosure is not limited to the embodiment described above, and various modifications may be adopted. For example, the crane 100 may be provided with an imaging device for imaging the boom hook 81 or a suspended load, and may be configured to recognize the position of the boom hook 81 or a suspended load by using the position of the lower end of the wire rope 82 by the lower-end wire positioning device 812 and the imaging information of the imaging device. The imaging device may be provided in the cab 4 or at the distal end of the boom 6.

The suspension fulcrum positioning device 652 installed at the distal end of the boom 6 is not limited to a GNSS positioning sensor. For example, the suspension fulcrum positioning device 652 may apply an inertial measurement device (hereinafter also referred to as an “IMU”) for measuring three-dimensional inertial motion. In this case, the controller 30 registers the initial position of the suspension fulcrum portion 6S at the distal end of the boom 6, and continuously acquires measurement information from the IMU when the boom 6 moves, so that the position of the suspension fulcrum portion 6S can be tracked (integrated).

The device for positioning the position of the lower end of the wire rope 82 is not limited to the lower-end wire positioning device 812. For example, the crane 100 may recognize the position of the lower end of the wire rope 82 by imaging the boom hook 81 and the suspended load with only an imaging device. The crane 100 may be provided with a LiDAR, a distance sensor, or another object recognition sensor, and recognize the position of the lower end of the wire rope 82 based on detection information from these sensors.

The device for positioning the target position TP is not limited to the target position positioning device TPS. For example, the crane 100 may recognize the target position TP by any one or a combination of the imaging device, the LiDAR, the distance sensor, or another object recognition sensor. Alternatively, an external device (Imaging device, LiDAR, distance sensor, other object recognition sensor) provided outside the crane 100 may recognize the position of the target position TP, and receive the position of the target position TP from the external device.

The receiving of an operation-assisted operation in is the crane 100 is not limited to receiving a slewing operation of the slewing operation lever (step S116 in FIG. 8). For example, the crane 100 may provide a start button for the operation assistance in the input device D2 or the like, and start the movement of the boom 6 (including the slewing control and the luffing control) based on an operation of turning the start button on. Conversely, when the start button is turned off, it is determined that the operation assistance is stopped, and the movement of the boom 6 is stopped. Thus, the operator can execute and stop the operation assistance at any timing. Alternatively, the crane 100 may use a brake switch provided in the slewing operation lever, and start the movement of the boom 6 based on turning off the brake (transitioning to the operable state) by an operation of turning the brake switch off. In this case, when the brake switch is turned on, the crane 100 determines that the operation assistance is stopped, and stops the movement of the boom 6.

The work machine is not limited to a crane applied to a construction work site, and may be a crane (low floor type, gate type, tower type) installed in a port or the like. The work machine is not limited to a mobile crane, and may be a fixed crane. Alternatively, the work machine may be an overhead crane, a bridge crane, or the like in which the movable part is suspended on the runway. The work machine may be a vehicle mounted with a crane, or a shovel with a crane function in which a wire rope is adopted as an attachment of the shovel.

### Modified Examples

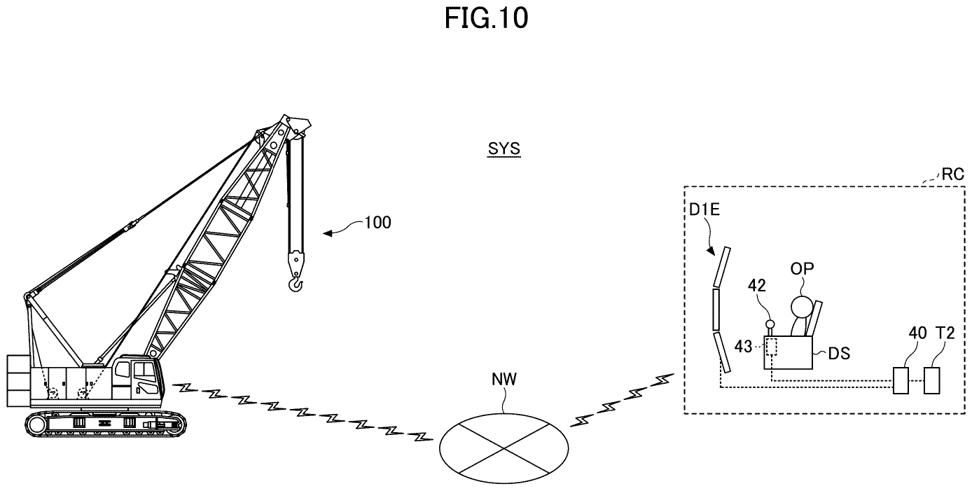

FIG. 10 is a schematic diagram illustrating a configuration example of the remote control system SYS of the crane 100 according to a modified example. As illustrated in FIG. 10, the remote control system SYS includes a remote control room RC. The crane 100 and the remote control room RC are connected to each other via a communication line NW so as to be capable of information communication.

The crane 100 transmits detection results of various sensors provided in the crane 100 to the remote control room RC using the communication device T1 provided in the crane 100. Furthermore, the crane 100 transmits image information picked up by an imaging device (not illustrated) to the remote control room RC.

The remote control room RC is provided with a display device D1E, an operation device 42, an operation sensor 43, an operator's seat DS, a remote controller 40, and a communication device T2.

The remote controller 40 includes the acquirer 301, the operation instruction receiver 302, the display controller 303, the registerer 304, the position identifier 305, the path generator 306, and the controller 307, which are provided in the controller 30 in the forgoing embodiment described above. The controller 307 generates a control command for controlling the crane 100, and transmits the generated control command to the crane 100 by using the communication device T2.

Therefore, the remote controller 40 can realize semi-automatic control of the crane 100 in a simple operation mode. Specifically, the remote controller 40 receives position information indicating respective positions used for moving the boom 6 from the crane 100, and registers the position information in a storage device in the remote controller 40. The respective positions include information about the position of the suspension fulcrum portion 6S, the position of the lower end of the wire rope 82, and the target position TP. The remote controller 40 can use the position information as positions used for automatically controlling the upper slewing body 3 and the boom 6. The path generator 306 can generate a target path based on the position information. The display device D1E displays the registered position information and the target path on a display area representing a workable space of the crane 100 by two-dimensional coordinates under the control of the remote controller 40.

Furthermore, when the slewing operation is performed by the operation device 42, the remote controller 40 transmits, to the crane 100, commands for control of slewing of the upper slewing body 3 and control of luffing of the front attachment 7, so that the boom 6 moves to the target position TP along the target path. Thus, the crane 100 moves the boom 6 and the boom hook 81 (the lower end of the wire rope 82) to the target position TP.

In this way, the crane 100 can be controlled even from a remote place by performing the operation in the remote control room RC. This makes it easier to secure a crane operator even when the worksite is in a remote location.

The technical concept and effects of the present disclosure described in the above embodiments will be described below.

A first aspect of the present disclosure is a work machine (crane 100) including a rope (wire rope 82) having a lower end portion (boom hook 81) configured to suspend a load, and a suspension fulcrum portion 6S configured to suspend the wire rope 82 and be movable, wherein the suspension fulcrum portion 6S is provided with a suspension fulcrum positioning device 652 configured to acquire position information of the suspension fulcrum portion 6S, and the suspension fulcrum portion 6S is moved based on the position information of the suspension fulcrum portion 6S acquired by the suspension fulcrum positioning device 652 and a set target position TP.

According to the above, by measuring the position of the suspension fulcrum portion 6S with the suspension fulcrum positioning device 652 provided at the suspension fulcrum portion 6S, the work machine (crane 100) can acquire position information more accurately than positioning performed using an imaging device, a LiDAR, or the like. The work machine can thereby suitably move the suspension fulcrum portion 6S with respect to the set target position TP, and can satisfactorily follow (move) the lower end of the wire rope 82 suspended by the suspension fulcrum portion 6S to the target position. Thus, the work machine can smoothly and accurately perform work such as conveying a suspended load.

A lower end (boom hook 81) of the rope (wire rope 82) is provided with a lower-end wire positioning device 812 configured to acquire position information of the lower end of the wire rope 82. Thus, the work machine (crane 100) can recognize the position of the lower end of the wire rope 82 more accurately than when recognizing the lower end of the wire rope 82 by using an imaging device, LiDAR, or the like. For example, the work machine can satisfactorily recognize sway (load sway) or the like of the lower end of the wire rope with respect to the suspension fulcrum portion 6S.

The lower-end wire positioning device 812 is provided as a pair, with the lower end of the rope (wire rope 82) interposed between the pair. Thus, the work machine (crane 100) can stabilize the center of gravity of the lower end (boom hook 81) of the wire rope 82 and suppress a phenomenon, such as rotation of the boom hook 81, by the lower-end wire positioning device 812.

The work machine (crane 100) further includes a controller 30 configured to control a movement of the suspension fulcrum portion 6S, and the controller 30 is configured to perform control for suppressing sway of the lower end (boom hook 81) of the rope (wire rope 82) based on the position information of the suspension fulcrum portion 6S acquired by the suspension fulcrum positioning device 652 and the position information of the lower end of the wire rope 82 acquired by the lower-end wire positioning device 812. Thus, the work machine (crane 100) can stabilize the lower end of the wire rope 82, and smoothly and accurately move the lower end of the wire rope 82.

The work machine (crane 100) further includes a controller 30 configured to control a movement of the suspension fulcrum portion 6S, and the controller 30 is configured to control the movement of the suspension fulcrum portion 6S based on the position information of the lower end of the rope (wire rope 82) acquired by the pair of the first portion and the second portion of the lower-end wire positioning device 812. Thus, the work machine (crane 100) can accurately monitor rotation and sway of the lower end of the wire rope 82 and effectively perform control for suppressing them.

The suspension fulcrum portion 6S includes a support (point sheave 651) configured to suspend the rope (wire rope 82) and a bracket (sheave bracket 650) configured to hold the point sheave 651. The suspension fulcrum positioning device 652 is fixed to the sheave bracket 650 and projects from the sheave bracket 650. When the position information of the suspension fulcrum portion 6S is calculated, an amount and a direction of the projection are taken into account for the position information measured by the suspension fulcrum positioning device 652. Thus, the work machine (crane 100) can stably receive the signals from various satellites from the projecting suspension fulcrum positioning device 652, and can position the position of the suspension fulcrum portion 6S with higher accuracy.

The suspension fulcrum positioning device 652 is a GNSS positioning device having an antenna 652b capable of receiving a satellite signal. The suspension fulcrum positioning device 652 includes a support (support bar 652d) configured to movably support the antenna 652b; and a weight 652c provided below the antenna 652b in a vertical direction and configured to cause a surface of the antenna 652b face upward in a vertical direction. Thus, the work machine (crane 100) can stably make the antenna 652b of the suspension fulcrum positioning device 652 face upward in the vertical direction to receive satellite signals, and can enhance the accuracy of positioning.

The work machine (crane 100) acquires position information of the target position TP transmitted from a target position positioning device TPS arranged at the target position TP, and the work machine moves the suspension fulcrum portion 6S in such a manner that the position of the suspension fulcrum portion 6S overlaps the acquired target position in the vertical direction. Thus, the work machine (crane 100) can recognize the position of the target position TP more accurately than when recognizing the target position TP using an image pickup device, LiDAR, or the like, and can accurately move the suspension fulcrum portion 6S so as to overlap the target position TP.

The work machine according to the embodiments disclosed herein is exemplary in all respects and is not intended to be limiting. The embodiments can be modified and improved in various forms without departing from the scope and gist of the appended claims. The matters described in the plurality of embodiments can have other configurations without contradiction and can be combined without contradiction.

In the embodiments, the work machine has been described using a crawler crane of a type that performs both traveling and slewing as an example, but the work machine is not limited to this, and the work machine can be applied to a machine device (including human power) having a slewing body capable of lifting a suspended load using power not including human power and carrying the suspended load substantially horizontally. For example, other mobile cranes having a slewing body (cranes incorporating prime mover and capable of moving to any kinds of place) include a truck crane, a wheel crane, a railway crane, and a floating crane. The machine device may be a fixed crane having a slewing body. Alternatively, the work machine is not limited to a crane, and a derrick may be applied.

What is claimed is:

1. A work machine comprising:
a rope having a lower end portion configured to suspend a load; and
a suspension fulcrum portion configured to suspend the rope and be movable, wherein
the suspension fulcrum portion is provided with a suspension fulcrum positioning device configured to acquire position information of the suspension fulcrum portion, and
the work machine is configured to move the suspension fulcrum portion based on the position information of the suspension fulcrum portion acquired by the suspension fulcrum positioning device and a set target position.

2. The work machine according to claim 1, wherein
a lower end of the rope is provided with a lower-end wire positioning device configured to acquire position information of the lower end of the rope.

3. The work machine according to claim 2, wherein
the lower-end wire positioning device includes a first portion of the lower-end wire positioning device and a second portion of the lower-end wire positioning device, with the lower end of the rope interposed between the first portion and the second portion of the lower-end wire positioning device.

4. The work machine according to claim 2, further comprising:
a controller configured to control movement of the suspension fulcrum portion, wherein the controller is configured to perform control for suppressing sway of the lower end of the rope based on the position information of the suspension fulcrum portion acquired by the suspension fulcrum positioning device and the position information of the lower end of the rope acquired by the lower-end wire positioning device.

5. The work machine according to claim 3, further comprising:
a controller configured to control movement of the suspension fulcrum portion, wherein the controller is configured to control the movement of the suspension fulcrum portion based on the position information of the lower end of the rope acquired by the first portion and the second portion of the lower-end wire positioning device.

6. The work machine according to claim 1, wherein
the suspension fulcrum portion includes a support configured to suspend the rope and a bracket configured to hold the support,
the suspension fulcrum positioning device is fixed to the bracket and projects from the bracket, and
when the position information of the suspension fulcrum portion is calculated, an amount and a direction of the projection are taken into account for the position information measured by the suspension fulcrum positioning device.

7. The work machine according to claim 6, wherein
the suspension fulcrum positioning device is a global navigation satellite system (GNSS) positioning device having an antenna capable of receiving a satellite signal, and
the suspension fulcrum positioning device includes
a support configured to movably support the antenna; and
a weight provided below the antenna in a vertical direction and configured to cause a surface of the antenna to face upward in a vertical direction.

8. The work machine according to claim 1, wherein
the work machine acquires position information of the target position transmitted from a target position positioning device arranged at the target position, and
the work machine moves the suspension fulcrum portion in such a manner that the position of the suspension fulcrum portion overlaps the acquired target position in the vertical direction.
